(19) United States
(12) Patent Application Publication
(10) Pub. No.: US 2008/0147867 A1
(43) Pub. Date: Jun. 19, 2008

(54) SYSTEM AND METHOD FOR MANAGING NETWORK CONNECTIVITY DISRUPTIONS IN A MULTI-HOMED UPNP DEVICE

(75) Inventor: Cathy Chan, Burlington, MA (US)

Correspondence Address: FOLEY & LARDNER LLP, P.O. BOX 80278, SAN DIEGO, CA, 92138-0278, US

(73) Assignee: Nokia Corporation

(21) Appl. No.: 11/610,473

(22) Filed: Dec. 13, 2006

(51) Int. Cl. G06F 15/16

(52) U.S. Cl. 709/227

(57) ABSTRACT

A system and method for minimizing interactions between a multi-homed device and associated control points in the event that the multi-homed device experiences connectivity disruptions in some, but not all, of its network interfaces. In various embodiments, a new optional header to the SSDP:byebye message format. The new header allows a multi-homed device to signal its continuous availability to compatible control points, despite the need to send SSDP:byebye messages, update its BOOTID value and re-advertise itself to address a network issue it experienced elsewhere. The use of this new header indicates to control points unaffected by the disruption that they can continue to utilize the device and its associated services regardless of these SSDP messages.

### FIELD OF THE INVENTION

The present invention relates generally to Universal Plug and Play (UPnP) technology. More particularly, the present invention relates to the use of the maintaining of availability of a multi-homed device in a UPnP environment when fewer than all of the device's network interfaces experience a connectivity disruption.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

UPnP technology defines an architecture for pervasive peer-to-peer network connectivity of intelligent appliances, wireless devices, and personal computer devices of all types. UPnP is designed to bring easy-to-use, flexible, standards-based connectivity to ad-hoc or unmanaged networks whether in the home, in a small business, public spaces, or attached to the Internet. UPnP technology provides a distributed, open networking architecture that leverages Transmission Control Protocol/Internet Protocol (TCP/IP) and Web technologies in order to enable seamless proximity networking, in addition to control and data transfer among networked devices.

The UPnP Device Architecture (UDA) is designed to support zero-configuration, “invisible” networking and automatic discovery for a breadth of device categories from a wide range of vendors. In other words, UPnP enables a device to be capable of dynamically joining a network, obtaining an IP address, conveying the device's capabilities, and learning about the presence and capabilities of other devices.

The UPnP Device Architecture standard (version 1.1) defines a BOOTID.UPNP.ORG header, referred to as BOOTID herein, in Simple Service Discovery Protocol (SSDP) messages. The BOOTID is a monotonically increasing value. When a device starts or performs a “reboot,” it must increase the value of the BOOTID. So long as a device remains available in the network, the same BOOTID value must be used in all repeat announcements, search responses and ultimately bye-bye messages. A device must use the same BOOTID value in all SSDP messages it sends on multiple network interfaces or IP addresses. In UPnP terminology, a “reboot” is defined as the announcing of device unavailability by sending SSDP:byebye messages, and subsequently re-announcing device availability by sending fresh SSDP:alive messages.

The BOOTID header is particularly useful in situations where a device detects a disruption in network connectivity, i.e. where the device has temporarily lost network connectivity but has regained connectivity (for example, a network cable was unplugged and re-plugged), or its IP address has changed. In such cases, the device increases its BOOTID value and reannounces itself on the network. Upon receiving an SSDP message with an increased BOOTID value, a control point that has cached information about the device understands that the device is no longer the same device. The control point typically reacts to this activity by refreshing the device information and potentially resubscribing to the device's services.

Despite the above, issues currently exist concerning the usage of the BOOTID in a multi-homed environment. A multi-homed device may have multiple network interfaces, multiple IP addresses on the same network interface, or both. Assuming a device has multiple network interfaces, for example, the device may be connected to one or multiple disjoint network segments through its network interfaces. A network connectivity disruption may occur on a network interface if the device briefly loses connectivity on the network interface, e.g., if the network cable is unplugged and then re-plugged, or if the IP address on the network interface changes. In this case, an issue arises as to whether and how the device updates the BOOTID value after such network connectivity disruptions.

In examining the above issue, it is helpful to consider a system as depicted in FIG. 1. As shown in FIG. 1, a device 100 has a first interface 110 and a second interface 120 which are connected to a first network segment 130 and a second network segment 140, respectively. A first control point 150 has a first control point interface 151 which is connected to the first network segment 130, and a second control point 160 has a second control point interface 161 which is connected to the second network segment 140. A third control point 170 is a multi-homed control point and is connected to both the first and second network segments 130 and 140 through third control point interfaces 171 and 172. Each of the first, second and third control points 150, 160 and 170 has cached some information about the device 100 and is subscribed to its services. In this situation, it is helpful to consider a situation where there is a brief network connectivity disruption on the first network interface 110 of the device 100 (and therefore on first network segment 130). From the perspective of first network segment 130 (and the first and third control points 150 and 170 connected to the first network segment 130), the device 100 has lost connectivity and needs to be “rebooted”. In other words, from the perspective of the first network segment 130, the device 100 should increase its BOOTID and re-advertise itself on the first network segment 130. On the other hand, from the perspective of second network segment 140 (and the second and third control points 160 and 170 which are connected to the second network segment 140), the device 100 has remained available throughout and a “reboot” is neither necessary nor expected. In other words, from the perspective of the second network segment 140, the device 100 should continue using its existing BOOTID in its subsequent announcements on the second network segment 140. However, because the device 100 is connected to both the first and second network segments 130 and 140, and because it must use the same BOOTID on both of them, a substantial problem exists.

Given that the control points connected on the first network segment 130 must be made aware that the device 100 has temporarily lost connectivity, the device 100 has no choice but to increase its BOOTID and re-advertise itself. However, this approach suffers from a side-effect that control points that are connected to the second network segment 140, and are not affected by the disruption, are also forced to refresh their device information. This has multiple repercussions. First, network traffic increases, as all control points need to refresh their device information. Second, the processing load on both the device 100 and the associated control points also increases. Third, this approach results in a less-than-friendly user experience. For example, if a user is using a UPnP-enabled computer that is connected to the Ethernet, and if there is a UPnP device connected to the home network via both the Ethernet and a wireless LAN (WLAN), if the WLAN connectivity is unstable, then the user would observe that the UPnP device repeatedly appears and disappears on the Ethernet, even though both the user and the UPnP device have been consistently connected on the Ethernet throughout the entire period. Fourth, the rebooting of the device also causes disruptions to the services that the control points may currently be consuming. For example, a file upload may need to be aborted, or a video playback may be interrupted if a reboot is necessary.

It would therefore be desirable to provide an improved system for managing connectivity disruptions in a multi-homed UPnP device in order to address the issues discussed above.

### SUMMARY OF THE INVENTION

Various embodiments of the present invention serve to minimize interactions between a multi-homed device and associated control points in the event that the multi-homed device experiences connectivity disruptions in some, but not all, of its network interfaces. In various embodiments, this is achieved by introducing a new optional header to the SSDP:byebye message format. The new header allows a multi-homed device to signal its continuous availability to compatible control points, despite the need to send SSDP:byebye messages, update its BOOTID value and re-advertise itself to address a network issue it experienced elsewhere. The use of this new header indicates to control points that they can continue to utilize the device and its associated services regardless of these SSDP messages.

The various embodiments of the present invention provide a number of benefits to users. The arrangements described herein can be backward compatible with UPnP v1.0 control points. Minimal processing is required on control points that are connected to the network interfaces that did not experience connectivity disruptions. Additionally, only a minimal amount of processing is required on the UPnP device because a minimal number of control points are impacted by the connectivity disruption. Still further, the various embodiments serve to greatly reduce the number of service disruptions to associated control points. Also, processing of the new optional header is optional; a control point that chooses to ignore the header can do so at the expense of having to re-establish device information, such as cached device states and event subscriptions. The various embodiments of the present invention can be incorporated into virtually any product that implements UPnP v 1.1 Device Architecture.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a depiction of a UPnP environment where a device includes multiple interfaces for use in associating with multiple network connections and control points;

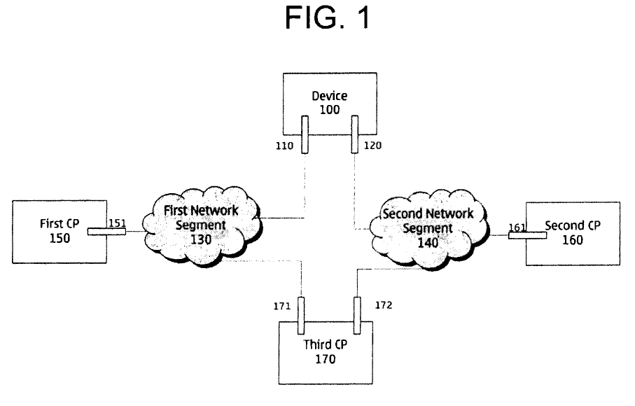

FIG. 2 is a flow chart showing the implementation of one general embodiment of the present invention;

FIG. 3 is perspective view of an electronic device that can be used in the implementation of the present invention; and

FIG. 4 is a schematic representation of the circuitry of the mobile telephone of FIG. 3.

### DETAILED DESCRIPTION OF VARIOUS EMBODIMENTS

The present invention serves to minimize the interactions between a multi-homed device and any associated control points in the event that the multi-homed device experiences connectivity disruptions in some, but not all, of its network interfaces. In various embodiments, this is achieved by introducing a new optional header NEXTBOOTID.UPNP.ORG (referred to herein as NEXTBOOTID) to the SSDP:byebye message format. The NEXTBOOTID header allows a multi-homed device to signal its continuous availability to compatible control points, despite the need to send SSDP:byebye messages, update its BOOTID value and re-advertise itself to address a network issue it experienced elsewhere. The use of the NEXTBOOTID header indicates to control points that they can continue to utilize the device and its associated services regardless of these SSDP messages.

The NEXTBOOTID.UPNP.ORG header can be included in SSDP:byebye messages sent by a multi-homed device, if the device experiences a disruption in the network connectivity on one of its network interfaces. The header is only included in messages sent over the network interfaces on which connectivity was not interrupted. On the network interface(s) where connectivity was disrupted, the header is not used. The value of the NEXTBOOTID.UPNP.ORG header indicates the BOOTID value that will be used in the upcoming SSDP announcement message. The device must remain continuously available on the network between the sending of the SSDP:byebye message with the NEXTBOOTID value and the next set of advertisement messages with the updated BOOTID value. Should the device become unavailable during this time, it must perform a regular “reboot,” incrementing the BOOTID and re-advertising itself.

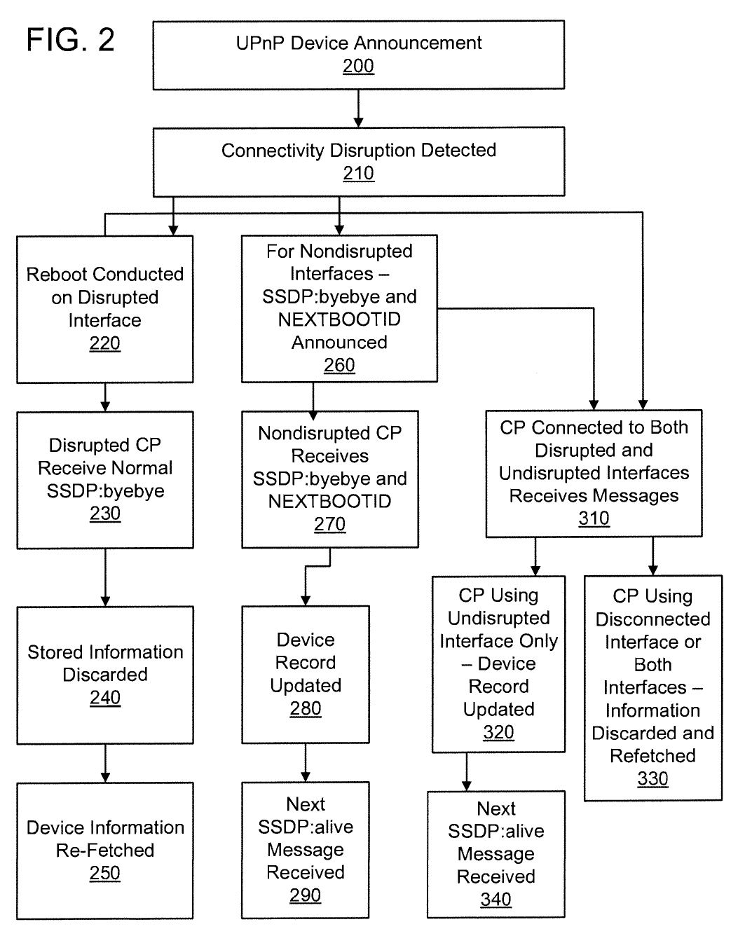

FIG. 2 is a flow chart showing an implementation of one general embodiment of the present invention. At 200 in FIG. 2, a UPnP device announces itself on all network interfaces with BOOTID=2. At a later time, the UPnP device at 210 detects that a connectivity disruption has occurred on one of its network interfaces. However connectivity on all other network interfaces remains intact. In response to this activity, at 220 the device performs a “reboot” on the network interface on which the disruption occurred by sending a SSDP:byebye message and re-advertising itself with a new BOOTID=3. Syntax for the SSDP:byebye message is as follows.

### NOTIFY*HTTP/1.1

### HOST: 239.255.255.250:1900

### NT: notification type

NTS: ssdp:byebye

### USN: composite identifier for the advertisement

### BOOTID.UPNP.ORG: 2

### CONFIGID.UPNP.ORG: number used for caching description information

### SEARCHPORT.UPNP.ORG number identifies port on which device responds to unicast M-SEARCH

At 260, for network interfaces where network connectivity has been intact, the device sends the SSDP:byebye message to announce the next BOOTID that will be used, along with new advertisements with the new BOOTID=3. Syntax for the SSDP:byebye message and the new advertisements are as follows.

### NOTIFY*HTTP/1.1

### HOST: 239.255.255.250:1900

### NT: notification type

NTS: ssdp:byebye

### USN: composite identifier for the advertisement

### BOOTID.UPNP.ORG: 2

### NEXTBOOTID.UPNP.ORG: 3

### CONFIGID.UPNP.ORG: number used for caching description information

### SEARCHPORT.UPNP.ORG number identifies port on which device responds to unicast M-SEARCH

Situations may arise where a UPnP 1.0 control point is communicatively connected to the UPnP device via a network interface and does not understand the BOOTID header and the NEXTBOOTID header. In this situation, the UPnP 1.0 control point simply treats the arrival of the SSDP:byebye and SSDP:alive messages as typical device “reboots.” In this case, the UPnP 1.0 control point typically discards any information that it has stored about the device and re-fetches all of device information, potentially also re-subscribing to its services. The behaviour is the same regardless of whether the UPnP 1.0 control point was connected to the device on the disrupted network interface or the intact network interface. In other words, a UPnP 1.0 control point is promptly alerted that the device has changed.

In terms of the behaviour of control points configured in accordance with version 1.1 of UPnP Device Architecture standard, these control points typically store the BOOTID information of any device that it is connected to. In the above example, the control point records that the device has a BOOTID=2. For a UPnP 1.1 control point that is connected to the network segment over which the device has a connectivity disruption, a normal SSDP:byebye message is received at 230. As represented at 240 in FIG. 2, the control point typically discards any information it has stored about the device. When the new SSDP:alive message arrives, the control point typically re-fetches all device information and possibly re-subscribes to its services, represented at 250. This is how the control point is successfully made aware of its new device state.

For a UPnP 1.1 control point that is connected to the network segment over which the device did not have a connectivity disruption, the SSDP:byebye message with the NEXTBOOTID header is received at 270. Noting that the BOOTID value of the SSDP:byebye message is identical to what it has recorded about the device (BOOTID=2), the control point recognizes that the device information it has recorded is still valid. The control point then updates its record of the device at 280 by updating the BOOTID to the value of the NEXTBOOTID header, resulting in BOOTID=3. When the next SSDP:alive message (with BOOTID=3) arrives at 290, the control point knows that it still has up-to-date information of the device. No re-fetching of device information or re-subscription to services is necessary.

For a UPnP 1.1 control point that is connected to both the network segment over which the device has experienced connectivity disruption and a network segment over which the device did not have a connectivity disruption, both SSDP:byebye messages with and without the NEXTBOOTID header sent by the device 100 at 220 and 260 are received by control point (over different network interfaces) at 310. In this situation, the behaviour of the control point depends on which interface the control point has been obtaining its device information and event subscriptions from. If the control point has been using solely the network segment over which the device did not have a connectivity disruption, i.e. the network segment from which the SSDP:byebye message with the NEXTBOOTID header was received, then the control point updates its record of the device at 320 by updating the BOOTID to the value of the NEXTBOOTID header, resulting in BOOTID=3. When the next SSDP:alive message (with BOOTID=3) arrives at 340, the control point knows that it still has up-to-date information of the device. No re-fetching of device information or re-subscription to services is necessary. If, on the other hand the control point has relied on the network segment over which the device has experience connectivity disruption, or has been relying on both network segments, then it would discard any information it has stored about the device, and re-fetch all device information, possibly re-subscribing to its services. These actions are collectively represented at 330 of FIG. 2.

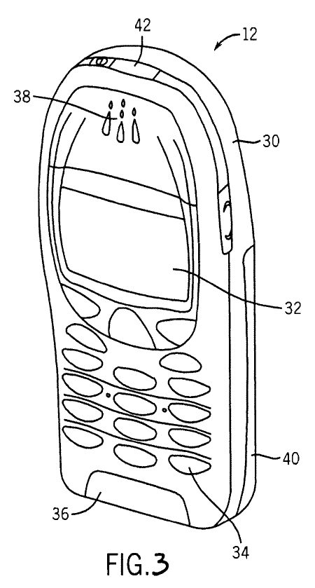

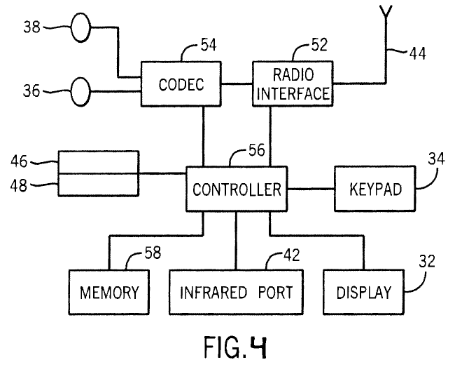

FIGS. 3 and 4 show one representative electronic device 12 within which the present invention may be implemented. It should be understood, however, that the present invention is not intended to be limited to one particular type of device. It should also be understood that some or all of the components shown in FIGS. 3 and 4 can be incorporated into any of the devices that are involved in implementing the various embodiments of the present invention. The electronic device 12 of FIGS. 3 and 4 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56, a memory 58 and a battery 80. Individual circuits and elements are all of a type well known in the art, for example in the Nokia range of mobile telephones.

Communication devices implementing the present invention may communicate with each other and/or other devices using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of managing network connectivity disruptions in a multi-homed device, comprising:
receiving an indication of a connectivity disruption on one of a plurality of interfaces for the device;
performing a reboot on the disrupted interface; and
on all interfaces where connectivity was not disrupted, transmitting an indication of a next BOOTID value.

2. The method of claim 1, wherein the transmission of the indication of the next BOOTID value causes control point devices associated with non-disrupted interfaces to update the BOOTID value of the device without having to discard stored information concerning the device and re-fetch information concerning the device.

3. The method of claim 1, wherein the indication of the next BOOTID value is transmitted within a NEXTBOOTID header.

4. The method of claim 1, wherein, for a control point device associated with both the disrupted interface and a non-disrupted interface:
if the control point device relies solely on a network segment associated with the non-disrupted interface, the indication of the next BOOTID value causes the control point device to update the BOOTID value of the device without having to discard stored information concerning the device and re-fetch information concerning the device; and
if the control point device relies at least partially on a network segment associated with the disrupted interface, the reboot causes the control point device to discard stored information concerning the device and re-fetch information concerning the device.

5. A computer program product, embodied in a computer-readable medium, including computer code for performing the processes of claim 1.

6. An apparatus, comprising:
a processor; and
a memory unit communicatively connected to the processor and including:
computer code for receiving an indication of a connectivity disruption on one of a plurality of interfaces for the apparatus;
computer code for performing a reboot on the disrupted interface; and
computer code for, on all interfaces where connectivity was not disrupted, transmitting an indication of a next BOOTID value.

7. The apparatus of claim 6, wherein the transmission of the indication of the next BOOTID value causes control point devices associated with non-disrupted interfaces to update the BOOTID value of the apparatus without having to discard stored information concerning the apparatus and re-fetch information concerning the apparatus.

8. The apparatus of claim 6, wherein the indication of the next BOOTID value is transmitted within a NEXTBOOTID header.

9. The apparatus of claim 6, wherein the indication of the next BOOTID value causes Universal Plug and Play (UPnP) version 1.0 control point devices to discard stored information regarding the apparatus and re-fetch information concerning the apparatus.

10. The apparatus of claim 6, wherein, for a control point device associated with both the disrupted interface and a non-disrupted interface:
if the control point device relies solely on a network segment associated with the non-disrupted interface, the indication of the next BOOTID value causes the control point device to update the BOOTID value of the apparatus without having to discard stored information concerning the apparatus and re-fetch information concerning the apparatus; and
if the control point device relies at least partially on a network segment associated with the disrupted interface, the reboot causes the control point device to discard stored information concerning the apparatus and re-fetch information concerning the apparatus.

11. The apparatus of claim 6, wherein the apparatus comprises a Universal Plug and Play (UPnP) device.

12. A system, comprising:
a Universal Plug and Play (UPnP) device including a first interface operatively connected to a first network segment and a second interface operatively connected to a second network segment;
a first control point device operatively connected to the first network segment;
a second control point device operatively connected to a second network segment; and
a third control point device operatively connected to both the first network segment and the second network segment,
wherein the UPnP device is configured to, upon the occurrence of a connectivity disruption at the first interface:
perform a reboot on the disrupted interface, and
transmit an indication of a next BOOTID value on the second interface.

13. The system of claim 12, wherein the reboot causes the first control point device to discard stored information regarding the UPnP device and re-fetch information concerning the UPnP device.

14. The system of claim 12, wherein the transmission of the indication of the next BOOTID value causes the second control point device to update the BOOTID value of the UPnP device without having to discard stored information concerning the UPnP device and re-fetch information concerning the UPnP device.

15. The system of claim 12, wherein the second control point device is a UPnP version 1.0 control point device, and wherein the transmission of the indication of the next BOOTID value causes the UPnP version 1.0 control point device to discard stored information regarding the UPnP device and re-fetch information concerning the UPnP device.

16. The system of claim 12, wherein
if the third control point device relies solely on the second network segment, the indication of the next BOOTID value causes the third control point device to update the BOOTID value of the UPnP device without having to discard stored information concerning the apparatus and re-fetch information concerning the UPnP device; and
if the third control point device at least partially on the first network segment, the reboot causes the third control point device to discard stored information concerning the UPnP device and re-fetch information concerning the UPnP device.

17. A method of updating information in a Universal Plug and Play (UPnP) control point device, comprising:
receiving from a device over an undisrupted interface an indication of a next BOOTID value for the device; and
in response to the received indication, at least selectively updating the BOOTID value of the device without discarding stored information concerning the device and re-fetching information concerning the device.

18. The method of claim 17, wherein the indication of the next BOOTID value is received within a NEXTBOOTID header.

19. The method of claim 17, wherein the indication of the next BOOTID value is received along with a SSDP:byebye message.

20. The method of claim 17, further comprising:
receiving a reboot indication from the device over a disrupted interface; and
if the UPnP control point device relies at least partially on a network segment associated with the disrupted interface, discarding stored information concerning the device and re-fetching information concerning the device.

21. The method of claim 20, wherein if the UPnP control point device relies solely on a network segment associated with the undisrupted interface, the BOOTID value of the device is updated without discarding stored information concerning the device and re-fetching information concerning the device.

22. A computer program product, embodied in a computer-readable medium, comprising computer code for performing the processes of claim 20.

23. An apparatus, comprising:
a processor; and
a memory unit communicatively connected to the processor and including:
computer code for processing an indication of a next BOOTID value for a device, the indication having been received from the device over an undisrupted interface; and
computer code for, in response to the received indication, updating the BOOTID value of the device without discarding stored information concerning the device and re-fetching information concerning the device.

24. The apparatus of claim 23, wherein the indication of the next BOOTID value is received within a NEXTBOOTID header.

25. The apparatus of claim 23, wherein the indication of the next BOOTID value is received along with a SSDP:byebye message.

26. The apparatus of claim 23, wherein the memory unit further comprises:
computer code for processing a reboot indication received from the device over a disrupted interface; and
computer code for, if the UPnP control point device relies at least partially on a network segment associated with the disrupted interface, discarding stored information concerning the device and re-fetching information concerning the device.

27. The apparatus of claim 26, wherein if the UPnP control point device relies solely on a network segment associated with the undisrupted interface, the BOOTID value of the device is updated without discarding stored information concerning the device and re-fetching information concerning the device.
